(19) United States
(12) Patent Application Publication
(10) Pub. No.: US 2025/0041725 A1
(43) Pub. Date: Feb. 6, 2025

(54) SYSTEM AND METHODS FOR ELECTRONIC GAMING CONTROL AND PERFORMANCE BASED SOUND GENERATION

(71) Applicant: Sony Interactive Entertainment Inc., Tokyo (JP)

(72) Inventors: Michael Taylor, San Mateo, CA (US); Coimbatore Ravi Madhavan, Sunnyvale, CA (US); Richard Olabode, Foster City, CA (US)

(73) Assignee: Sony Interactive Entertainment Inc., Tokyo (JP)

(21) Appl. No.: 18/363,697

(22) Filed: Aug. 1, 2023

(51) Int. Cl. A63F 13/54; A63F 13/355; A63F 13/798

(52) U.S. Cl. CPC A63F 13/54; A63F 13/355; A63F 13/798

(57) ABSTRACT

Systems, processes and device configurations are provided for electronic gaming control and performance based sound generation for network games, such as multiplayer or cloud based games. Processed include determining one or more sound cues for a game data stream. By generating and outputting one or more sound cues on the fly, sound feedback may be provided to compliment gameplay and a game experience. Sound cues can transform or modify audio elements of games for users and viewers of electronic gaming content. Generating sound cues may include replacing one or more assets of an electronic game, and capturing the user interaction with the modified content. Generating sound cues may include generating one or more sounds for a user, such as crowd cheers or boos, wherein the underlying game code and game content is not modified. Processes and configurations are also provided for determining sound assets of gaming content and tracking user performance.

### FIELD

The present disclosure is directed to interactive entertainment and electronic video gaming, including gaming device operations, processes, configurations, user interface control and control device configurations.

### BACKGROUND

Computer and console games offer players different types of gaming experiences. Network electronic games, such as multiplayer games, allow users to interact and play electronic games with one or more other users over the network. Game titles popular for network gaming include fighting games, first person shooters, third-person shooters, multiplayer online battle, racing, and strategy games. Network electronic games are popular for personal use and for game competitions including Esports (electronic sports, competition using video games). Often, feedback of a network game is limited to graphical content of a game and sound components of a game provided to a user. There is a need to provide users of network games additional feedback. Similarly, there is a need to provide viewers of gaming content features with game streams.

### BRIEF SUMMARY OF THE EMBODIMENTS

Disclosed and described herein are systems, methods and configurations for electronic gaming control and performance based sound generation. In one embodiment, a method includes receiving, by a device, a game data stream for an electronic game, wherein the game data stream includes game data for at least one user of the electronic game. The method also includes analyzing, by the device, performance of the at least one user using the game data stream. The method also includes determining, by the device, at least one sound cue for the at least one user of the electronic game, wherein the at least one sound cue is determined based on the performance of the at least one user. The method also includes updating, by the device, the game data stream for the at least one user of the electronic game to include the at least one sound cue, The method also includes controlling, by the device, output of the game data stream and at least one sound cue.

In one embodiment, receiving the game data stream includes identifying at least one sound asset of the game data stream for the at least one user, and wherein updating the game data stream includes replacing the at least one sound asset with the at least one sound cue.

In one embodiment, analyzing performance of the at least one user includes tracking user performance for the electronic game a for a period of time and determining a performance rating for the user for a period of time associated with a received game data stream.

In one embodiment, the at least one sound cue includes at least one sound effect added to audio data of the game data stream to indicate user performance level.

In one embodiment, the at least one sound cue is a control setting for control of at least one of game sound effect volume and game chat volume.

In one embodiment, the at least one sound cue is generated to include a sound effect for at least one of excited approval and a disapproval sound.

In one embodiment, the at least one sound cue is generated to indicate user performance relative to multiplayer users of a gaming session.

In one embodiment, updating the game data stream for the at least one user of the electronic game includes reducing volume of the game data stream for a period of time associated with poor user performance.

In one embodiment, updating a game data stream includes at least one of embedding and adding a sound component of a sound cue to a game data stream for output.

In one embodiment, the method includes detecting a user reaction to the sound cue and controlling a game data stream based on the user reaction.

Another embodiment is directed to a device configured for electronic gaming control and performance based sound generation. The device includes an interface, memory storing executable instructions, and a controller coupled to the interface and memory. The controller is configured to receive a game data stream for an electronic game, wherein the game data stream includes game data for at least one user of the electronic game. The controller is configured to analyze performance of the at least one user using the game data stream. The controller is configured to determine at least one sound cue for the at least one user of the electronic game, wherein the at least one sound cue is determined based on the performance of the at least one user. The controller is configured to update the game data stream for the at least one user of the electronic game to include the at least one sound cue, and control output of the game data stream and at least one sound cue.

Other aspects, features, and techniques will be apparent to one skilled in the relevant art in view of the following detailed description of the embodiments.

### BRIEF DESCRIPTION OF THE DRAWINGS

The features, objects, and advantages of the present disclosure will become more apparent from the detailed description set forth below when taken in conjunction with the drawings in which like reference characters identify correspondingly throughout and wherein:

FIG. 1 is a graphical representation of electronic gaming control and performance based sound generation according to one or more embodiments;

FIG. 2 illustrates a process for electronic gaming control and performance based sound generation according to one or more embodiments;

FIG. 3 illustrates a graphical representation of a device configuration according to one or more embodiments;

FIG. 4 illustrates a graphical representation of game data streams according to one or more embodiments; and

FIG. 5 illustrates a graphical representation of sound cue training according to one or more embodiments.

### DETAILED DESCRIPTION OF THE EXEMPLARY EMBODIMENTS

### Overview and Terminology

One aspect of the disclosure is directed to dynamic sound generation for electronic games and sound generation based on player performance. According to embodiments, processes and device configurations are provided for network games, such as multiplayer or cloud based games, that include one or more streams of audio. Embodiments determine and generate one or more sound cues for a user. By generating one or more sound cues on the fly and outputting the sound cues, sound feedback may be provided to compliment gameplay and a game experience. Sounds cues discussed herein can transform and/or modify audio elements for one or more of users, such as a player of an electronic game, and viewers of gaming content. According to embodiments, generating sound cues may include replacing one or more assets on the fly, presenting to a user, and capturing the user interaction with the modified content. According to other embodiments, generating sound cues may include generating one or more sounds for a user, wherein the underlying game code and game content is not modified. In addition, sound cues may be generated to provide feedback, such as feedback on performance. Sound cues may include adding or modifying one or more audio elements to a game stream, or provided separate from but in addition to the game stream, such as cheers or applause for good performance and boos or whistles for poor performance. Alternatively or in combination, sound cues may include adding sound elements to one or more game streams to replace sound elements. By way of example, sound cues maybe generated to replace sounds indicating an accomplishment or completion of a game task. According to embodiments, sound cues may be used to control one or more audio elements of an electronic game. By way of example, one or more of volume and tonal quality of game chat may be controlled based on sound cues. Poor performance in a game may soften, reduce volume and/or mute game chat audio for a user. Embodiments provide processes and device configurations to determine, control and output sound cues for electronic games without modifying or changing base game code. As such, when player performance improves or degrades, new sound assets may be generated specifically for the game session. The sound assets can in turn reflect the player performance.

According to embodiments, processes and device configurations are provided for generating sound cues using one or more sound assets of a game. Processes and device configurations can include detection and processing of game data using one more models, such as a machine learning (ML) model, to extract sound assets of a game including sound effects, background sounds, gaming music and game chat data. Embodiments may including generating one or more sounds based on detected sound assets. In addition, sound cues may be generated for one or more users based on detected sound assets and models. Sound cues generated for a user may be generated on the fly and added to a cloud game stream in order to affect the player's game play or experience. The model may be used by a device to modify and transform game streams during gameplay sessions. New sound assets may be generated using the model to reflect player performance.

Another aspect of the disclosure is providing performance feedback to users. According to embodiments, processes and device configurations may include tracking performance of players. One or more of player scores, rankings, results, errors and game events may be detected form game streams. Player performance may be determined relative to tracked performance and/or other players of a stream. Dynamic sound asset generation may be based on player performance determinations to include generating one or more sound cues and capturing user interaction.

Embodiments are directed to systems, devices and methods for game operations and controls, including operations for sound cues, sound assets, player performance feedback and game presentation. Embodiments may be performed by gaming systems including one or more of consoles and network devices such as servers (e.g., cloud server, network server, back end server, etc.). Gaming systems may include consoles that play game media, consoles that provide network data for games, handheld devices, mobile devices (e.g., tablets, mobile phones, etc.) and devices in general configured for electronic gaming.

As used herein, the terms “a” or “an” shall mean one or more than one. The term “plurality” shall mean two or more than two. The term “another” is defined as a second or more. The terms “including” and/or “having” are open ended (e.g., comprising). The term “or” as used herein is to be interpreted as inclusive or meaning any one or any combination. Therefore, “A, B or C” means “any of the following: A; B; C; A and B; A and C; B and C; A, B and C”. An exception to this definition will occur only when a combination of elements, functions, steps or acts are in some way inherently mutually exclusive.

Reference throughout this document to “one embodiment,” “certain embodiments,” “an embodiment,” or similar term means that a particular feature, structure, or characteristic described in connection with the embodiment is included in at least one embodiment. Thus, the appearances of such phrases in various places throughout this specification are not necessarily all referring to the same embodiment. Furthermore, the particular features, structures, or characteristics may be combined in any suitable manner on one or more embodiments without limitation.

### Exemplary Embodiments

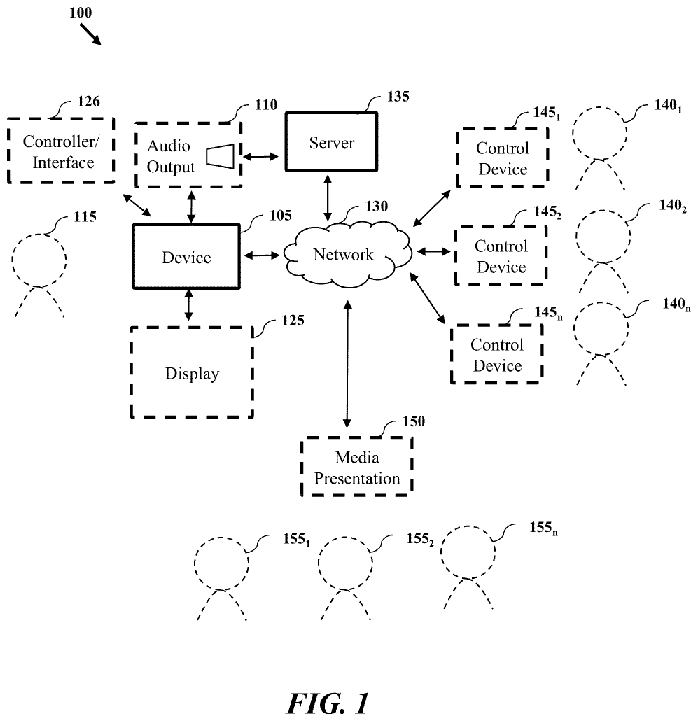

FIG. 1 is a graphical representation of electronic gaming control and performance based sound generation according to one or more embodiments. Electronic gaming control and performance based sound generation may be performed by one or more devices of system 100. Operations of system 100 may be performed by control devices, such as device 105 which may be a game console, and/or one or more network devices, such as server 135. According to embodiments, system 100 may include one or more servers, such as server 135 to service one or more control devices. According to embodiments, system 100 includes device 105, which may be a game console, entertainment device, display device or media player. System 100 may also include server 135 which may be a network device configured to provide game data to one or more devices, such as network or multiplayer games. According to embodiments, at least one of device 105 and server 135 may be used to output an electronic game for one or more users, such as user 125. According to embodiments, device 105 may perform one or more operations on a game stream for electronic gaming control and performance based sound generation. Similarly, server 135 may be configured to perform one or more operations on a game stream.

Device 105 may be configured for presenting game media for a user, receiving user controls and providing user control and game data to a network device, such as server 135, for one or more game functions. Server 135 may be configured to host and provide data for more game services. According to embodiments, a game stream may include data received by and/or provided to device 105 from server 135. During operation of a game, a game data stream may be provided to one or more devices, such as device 105 to allow for presentation of game content. System 100 may be configured to control presentation of content associated with an electronic game including one or more sound cues. System 100 may also be configured for tracking user performance for generation of one or more sounds.

Control device 105 may be configured to control and present gaming content for one or more users, such as user 115. According to embodiments, system 100 may include audio output 110 having one or more speakers to output sound cues and audio of game data. Similarly, control device 105 may operate with one or more peripherals or control devices, such as an optional controller/interface 126 (e.g., handheld controller) and optional display 125. Audio output 110 may be internal to one or more devices and/or connected to one or more devices, such as device 105, display 125 and controller 126. Device 105 may receive audio data, such as voice recordings or detected voice output 120 from user 115. Device 105 may be configured to receive user controls by way of one or more controllers, such as controller 126. Controller 126 may be an interface, such as a touch screen, of control device 105. According to embodiments, device 105 may output gaming content to display 125. Communication with server 135 may be by way of network 130 to provide one or more multiplayer game operations.

According to embodiments, system 100 is configured to allow for control and presentation of electronic gaming content, such as content associated with a multiplayer game. In addition, embodiments are directed to providing gaming content based on user performance. System 100 may also be configured to output gaming content and sound cues to one or more viewers. Sound cues may be generated based on user performance, and user performance data may be collected to determine one or more user details. It should be appreciated that operations and processes for collection of user data, including user voice and user audio, may be based on expressed consent of a user. Users may be notified of operations and collection of user data. Operations may also require adult confirmation and user agreement for operations to be performed on a console or a device. System 100 may provide features to improve user experience, wherein functions and operations described herein are performed following user consent, with express notice to a user, and/or in alignment with one or more user settings for user privacy. It should be appreciated that embodiments may be applied to interactive entertainment with one or more users. Processes described herein are not limited to gaming content.

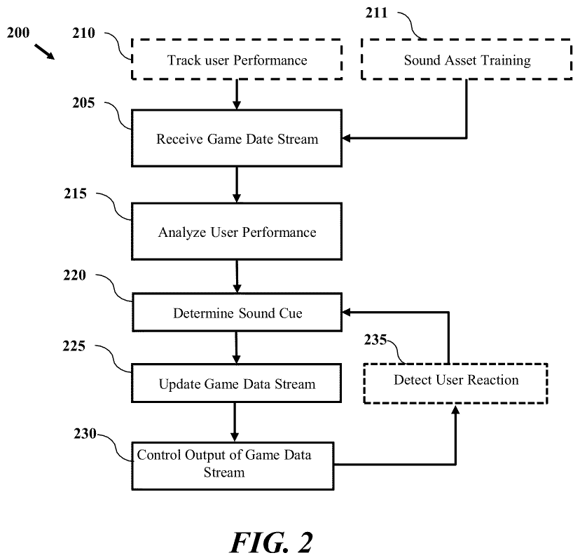

As discussed below in more detail with respect to FIGS. 2, 4 and 5, processes are provided for electronic gaming control and performance based sound generation relative to one or more users, such as user 115 and users accessible by way of a network. System 100 may operate for multiplayer games. According to embodiments, server 135 may be configured to provide game data streams to one or more users, such as user 115 and users 1401-n for a multiplayer game. Accordingly, server 135, and one or more additional servers of system 100, may be configured to manage a multiplayer gaming session for one or more devices, such as device 105 and one or more of control devices 1451-n associated with users 1401-n.

According to embodiments, server 135 may include a memory and/or database for storing one or more of game data, sound assets used in games and sound cues. Server 135 may also provide one or more multiplayer functions, such as providing a voice channel/game chat for multiplayer games. Voice output of user 115 may be detected by controller/interface 126, received by device 105 and output to one or more devices of system 100 to provide an in game voice chat feature and to detect user reactions.

According to embodiments, a device of system 100, such as at least one of device 105 and server 135, may control an electronic game for a user and performance based sound generation. Control may be network based, such that one or more operations are performed by server 135. Device 105 may be local to user 115 and may perform one or more operations local to user 115. According to embodiments, one or more components of system 100, such as device 115 and server 135 may perform processes relative to one or more game streams. By way of example, device 105 may be providing user 115 with an electronic game on device 105 and device 105 may exchange data, in the form with server 135 over network 130. Server 135 may receive data from one or more other devices, such as control devices 1451-n for users 1401-n. According to embodiments, a game data stream generated for device 105 associated with user 115 may include game data for one or more game elements controlled by user 115 and one or more game elements associated with users 1401-n. According to embodiments, system 100 may perform one or more processes for receiving a game data stream for an electronic game, analyzing performance of au user and determining at least one sound cue. System 100 may update the game data stream to include the at least one sound cue and output the game stream. By way of example, detection of user 115 performing well in a game may result in system 100 generating an applause or crowd cheering sound to output as audio data to the use by way of audio output 110. Similarly, poor performance by user 115 may result in generating a sound cue for a crowd boo sound to be output to a user. As discussed herein, sound cues can include replacing sounds of an electronic game, adding sounds to a game stream of an electronic game, and control audio output for a user. According to embodiments, server 135 may be one of a network server, backend server, game server, and server device in general. configured to provide a multiplayer game data. Server 135 may be configured to perform one or more operations with respect to generating a user profile for a user, such as user 115 and may be configured to receive detected user voice output 120.

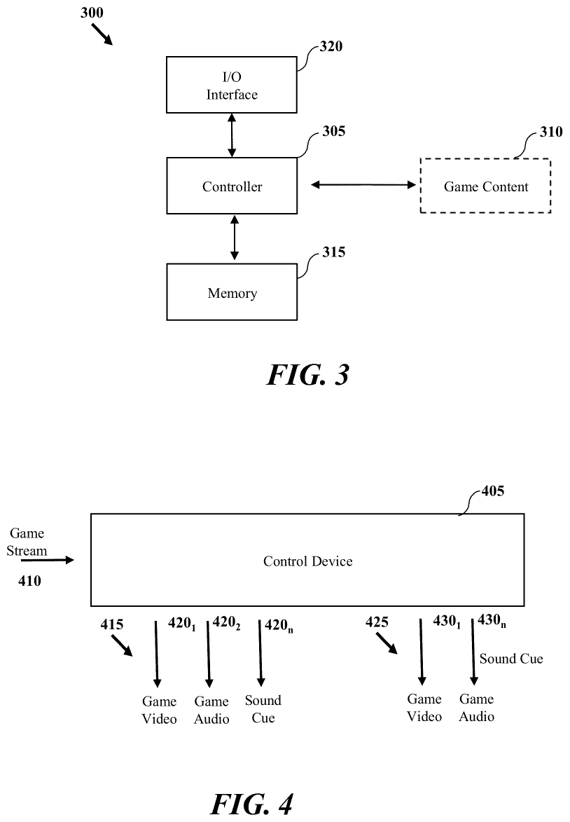

FIG. 2 illustrates a process for electronic gaming control and performance based sound generation according to one or more embodiments. Process 200 may determine one or more sound cues for an electronic game. In addition, process 200 may track user performance and provide feedback to a user for one or more of entertainment, training and personalization. Process 200 may be performed by a device, such as device 105 or server 135 of FIG. 1, controller 305 of FIG. 3, or a control device in general.

Process 200 may be initiated by a device receiving a game data stream at block 205. When performed by a network device, such as server 135, the game stream data may include data received from one or more user devices, such as game consoles or media players. The server device may be configured to process game streams from users to determine one or more game actions and data to broadcast to users of a multiplayer game. When performed by a control device local to or associated with a user, such as device 105 associated with user 115, the game data stream may include one or more components for presentation of a game. Control devices and consoles may include media or game data local to presentation of a game, the game media configured to receive one or more game data streams to allow for multiplayer gameplay. Process 200 is described below as being performed by a device. According to embodiments, process 200 may be performed by one or more of control devices, consoles and network devices such as servers.

At block 205, process 200 includes receiving a game data stream for an electronic game, the game data stream including game data for at least one user of the electronic game. For example the game data stream can include one or more of graphics, code to direct graphics, audio data, and code describing audio to present for a game. At block 205, process 200 can include identifying at least one sound asset of the game data stream for the at least one user. Depending on the game, one or more types of audio may be output to a user including background sounds or music and one or more sound effects associated with game actions. These sound elements of the game may be sound assets used by the game and may be part of the game code/game media. Process 200 may update a game data stream to include replacing one or more sound assets detected with at least one sound cue. According to embodiments, control of sound cues may be based on user performance. One example of generating a sound cue may be the addition of sounds representing or sounding like crowd noise, such as cheers and boos. In a multiplayer game, the game media may only include game sounds, and not provide feedback of user performance with respect to other players. Similarly, there may not be sound effects for an audience that is viewing gameplay. According to embodiments, game data streams may be live or associated with game data streams for a game session that is currently being played. In certain embodiments, process 200 may be applied to recorded game streams or video content that is being broadcast.

According to embodiments, process 200 optionally performs tracking user performance at block 210. Tracking user performance can include storing one or more of user scores, user rankings, user game progress and user game data in general to determine one or more points of reference for analyzing user performance in one or more electronic games. For multiplayer games, tracking user performance can include tracking user rank or standing for game sessions. Tracking user performance can include storing user data for one or more game titles.

According to embodiments, process 200 optionally performs sound asset training at block 211. Sound assert training may include identification of one or more sounds, sound effects, and audio elements of a game. Sound assets may be audio elements that are part of game data. Sound asset determination may be based on a particular game title. Although some game titles may use similar sounds for certain graphical elements, characters or actions, sound assets may be determined for a game title and/or based on data in a game data stream.

At block 215, process 200 includes analyzing performance of the at least one user using the game data stream. According to embodiments, analyzing performance of the at least one user includes tracking user performance for the electronic game a for a period of time and determining a performance rating for the user for a period of time associated with a received game data stream. User performance may be determined based on data determined for a user, such as tracked user performance at block 210 and one or more user scores or rankings for an electronic game. Game data such as a players current rank, score total, level, achievements, etc. can be used and determined from a game stream and/or game engine data to determine how a player is performing. Analysis may include a determination of a player performing well, poorly, or within a rating system from poor to well. One or more sound cues may be determined at block 220 based on user performance. Sound cues may be determined based on based on the performance of the at least one user. By way of example, a sound cue can include at least one sound effect added to audio data of the game data stream to indicate user performance level.

Sound cues may be one or more of sound effects, music, and sound clips presented to modify, replace or control sound of a game stream. Sound cues may be generated by a device on the fly, meaning based on the current game data stream the sound cue may be generated, selected and/or output. As such, events in a game stream that fluctuate, such as user performance may be addressed based on the current game state. Game sound effects in a game title, and game audio in general, may not account for every situation and/or address users performance relative to a game data stream and user performance.

According to embodiments, a sound cue is generated to include a sound effect for at least one of excited approval and disapproval. According to embodiments, one or more sound effects or clips may be output based on user performance and to provide feedback to a user. By way of example, one or more sounds such as cheering, crowd cheers, and positive encouragement messages may be output when user performance is rated well. Similarly, when user performance drops or is determined to be underperforming, one or more of a boo, chant or crucial sound cue may be generated. According to embodiments, a sound cue is generated to indicate user performance relative to multiplayer users of a gaming session. As such, user performance and game data streams may be analyzed to compare user scores or rankings to one or more other players of a multiplayer game. User performance may be compared using data within the game stream, such as displayed scores or rankings.

According to embodiments, a sound cue may be a control setting for control of at least one of game sound effect volume and game chat volume. By way of example, when player performance is determined to be poor or underperforming, volume and/or sound output characteristics of one or more elements of a game data stream may be adjusted. Control of audio can include muting or muddling audio of a game chat, reducing sound effects, blocking or changing in game music, etc. According to embodiments, as player performance degrades, the voice chat of co-operative players could also degrade in quality. Alternatively, impact sounds made by the player or by other agents in the game environment will become heavier and louder.

According to embodiments, as user performance improves, voice chat may be become clearer, and the loudness and impact of sound assets will return to normal. Output of game data can include one or more graphical elements to highlight that a sound element has been replaced. Output of sound cues may be controlled to tie into one or more game actions. By providing a sound cue, a temporal aspect of feedback may be provided to a user based on user actions. The feedback can complement and expand upon gaming experiences.

Sound assets in process 200 may be fully dynamic, and only available as the game is streamed to the user. According to embodiments, sound cues may be used to change dialogue of one or more in game of NPC comments. Sound cues may also be generated based on the game title category or type. For example, game cues may be generated for sports games based on the in game actions such as louder cheers for a home run compared to a sound of frustration with a strikeout.

At block 220, process 200 includes updating a game data stream for the at least one user of the electronic game to include the at least one sound cue. Updating a game data stream includes at least one of embedding and adding a sound component of a sound cue to a game data stream for output. Updating the game data stream can include reducing volume of the game data stream for a period of time associated with poor user performance.

At block 230, process 200 includes controlling output of the game data stream and at least one sound cue. One or more sound cues may be presented by way of audio output devices to a user. Sound cues may be fit to one or more graphical aspects of a game.

Process 200 may optionally include detecting a user reaction to sound cues at block 235. The device may control a game data stream based on the user reaction. By way of example, one or more of reactions, phrases and emotional responses may be detected in response to sound cues.

FIG. 3 illustrates a graphical representation of a device configuration according to one or more embodiments. Device 300 is configured for detecting user performance for an electronic game and sound generation. Device 300 can provide one or more components and functions of device 105. Device 300 may represent one or more of a gaming console, computing device and electronic device in general configured to output one or more of video, audio and game data to an output device. Device may provide one or more components of a server or network device.

Device 300 may be a control device or game console device which can include controller 305, memory 315 and input/output (I/O) interface 320. Device 300 may also optionally include game content 310. Controller 305 may relate to a processor or control device configured to execute one or more operations stored in memory 315, such as processes for detecting user socialization preferences and processes for gameplay matchmaking. Memory 315 may be non-transitory memory configured to provide data storage and working memory operations for device 300. Memory 315 may be configured to store computer readable instructions for execution by controller 305 for one or more processes described herein.

Device 300 may be configured to receive gaming media (e.g., card, cartridge, disk, etc.) and output visual and audio content of the gaming media to an output device, such as a display. Device 300 may be configured to provide a voice communication features for users of a game, such as a game chat. Control device 305 may be configured to receive game data streams by way of I/O interface 320. Controller 305 may also be configured for tracking user performance and generating one or more sound cues. Controller 305 may be configured to store a user profile and/or update a user profile stored on a network.

Controller 305 may be configured to receive data from one or more other devices such as console and servers (e.g., server 135) to present and output game content. For network games, controller 305 may receive game data from a network source, such as a server, by way of a network and may be configured to control audio features, including sound cues. Controller 305 may be configured to receive input from one or more peripheral devices.

FIG. 4 illustrates a graphical representation of game data streams according to one or more embodiments. Control of a gameplay session and/or electronic game can include providing graphical and/or audio content to a user from one or more sources including game media, a user control device (e.g., gaming console, media player, etc.) and a network device. According to embodiments, control device 405 may be configured to receive game streaming data. FIG. 4 illustrates output of sound cues according to one or more embodiments.

Based on a received game stream 410, output of game content 415 can include game video data 420₁, game audio data 420₂, and at least one sound cue 420ₙ. Output of game content 415 includes one or more sound cues added to the output game stream. According to embodiments, based on a received game stream 410, output of game content 425 can include game video data 410₁, and game audio data 430ₙ, wherein the game audio data includes one or more sound cues embedding into the game audio. Embedding sound cues in the game audio can include replacing and/or adding one or more sound components to audio output for a game.

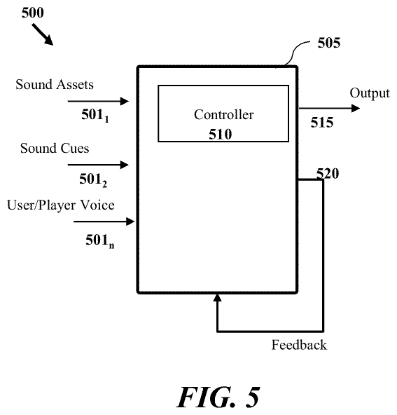

FIG. 5 illustrates a graphical representation of sound cue training according to one or more embodiment. Process 500 may be performed to determine one or more sound signatures for an electronic game. Once a sound signature is determined, sound assets of the game may be used to identify one or more sounds that align with game content.

FIG. 5 illustrates training process 500 which can include receiving training parameters 501₁₋ₙ as training input by a device 505 including a controller 510. According to embodiments, controller 510 may receive a plurality of forms of audio data samples as training input. In embodiments, training parameters 501₁₋ₙ may include sound assets, sound cues and user/player voice. Voice data may be labeled as examples of users to gaming content. Based on the training in process 500, controller 510 may generate output 515. Output 515 may include one or more audio control parameters for filtering and/or control of sound cues and game audio data. According to embodiments, controller 510 may be configured to generate output 515 based on a recursive loop including training and feedback. Feedback loop 520 may provide information such as ratings and accuracy for output 515.

According to embodiments, training process 500 and controller 510 may be configured to use one or more learning models (e.g., artificial intelligence, iterative models, etc.) to game audio. Training process 500 and controller 510 may use one or more libraries of game audio examples. According to embodiments, output 515 may include output of game audio modified based on one or more sound cues.

Training process may be used to identify dynamic sounds based on player performance for cloud based gaming. Process 500 may also be used for generating sound cues on the fly and adding them to a cloud game stream in order to affect the player's game play or experience. By transforming a stream and replacing sound assets on the fly, game content may be modified for displaying it to the user, capturing the user interaction with the modified content, and then applying that the base game. These operations may be performed without modifying underlying game code.

While this disclosure has been particularly shown and described with references to exemplary embodiments thereof, it will be understood by those skilled in the art that various changes in form and details may be made therein without departing from the scope of the claimed embodiments.

What is claimed is:

1. A method for electronic gaming control and performance based sound generation, the method comprising:
receiving, by a device, a game data stream for an electronic game, wherein the game data stream includes game data for at least one user of the electronic game;
analyzing, by the device, performance of the at least one user using the game data stream;
determining, by the device, at least one sound cue for the at least one user of the electronic game, wherein the at least one sound cue is determined based on the performance of the at least one user; and
updating, by the device, the game data stream for the at least one user of the electronic game to include the at least one sound cue; and
controlling, by the device, output of the game data stream and at least one sound cue.

2. The method of claim 1, wherein receiving the game data stream includes identifying at least one sound asset of the game data stream for the at least one user, and wherein updating the game data stream includes replacing the at least one sound asset with the at least one sound cue.

3. The method of claim 1, wherein analyzing performance of the at least one user includes tracking user performance for the electronic game a for a period of time and determining a performance rating for the user for a period of time associated with a received game data stream.

4. The method of claim 1, wherein the at least one sound cue includes at least one sound effect added to audio data of the game data stream to indicate user performance level.

5. The method of claim 1, wherein the at least one sound cue is a control setting for control of at least one of game sound effect volume and game chat volume.

6. The method of claim 1, wherein the at least one sound cue is generated to include a sound effect for at least one of excited approval and a disapproval sound.

7. The method of claim 1, wherein the at least one sound cue is generated to indicate user performance relative to multiplayer users of a gaming session.

8. The method of claim 1, wherein updating the game data stream for the at least one user of the electronic game includes reducing volume of the game data stream for a period of time associated with poor user performance.

9. The method of claim 1, wherein updating a game data stream includes at least one of embedding and adding a sound component of a sound cue to a game data stream for output.

10. The method of claim 1, further comprising detecting a user reaction to the sound cue and controlling a game data stream based on the user reaction.

11. A device configured for dynamically analyzing and modifying a game environment, the device comprising:
an interface;
a memory storing executable instructions; and
a controller coupled to the interface and the memory, wherein the controller is configured to
receive a game data stream for an electronic game, wherein the game data stream includes game data for at least one user of the electronic game;
analyze performance of the at least one user using the game data stream;
determine at least one sound cue for the at least one user of the electronic game, wherein the at least one sound cue is determined based on the performance of the at least one user;
update the game data stream for the at least one user of the electronic game to include the at least one sound cue; and
controlling, by the device, output of the game data stream and at least one sound cue.

12. The device of claim 11, wherein receiving the game data stream includes identifying at least one sound asset of the game data stream for the at least one user, and wherein updating the game data stream includes replacing the at least one sound asset with the at least one sound cue.

13. The device of claim 11, wherein analyzing performance of the at least one user includes tracking user performance for the electronic game a for a period of time and determining a performance rating for the user for a period of time associated with a received game data stream.

14. The device of claim 11, wherein the at least one sound cue includes at least one sound effect added to audio data of the game data stream to indicate user performance level.

15. The device of claim 11, wherein the at least one sound cue is a control setting for control of at least one of game sound effect volume and game chat volume.

16. The device of claim 11, wherein the at least one sound cue is generated to include a sound effect for at least one of excited approval and a disapproval sound.

17. The device of claim 11, wherein the at least one sound cue is generated to indicate user performance relative to multiplayer users of a gaming session.

18. The device of claim 11, wherein updating the game data stream for the at least one user of the electronic game includes reducing volume of the game data stream for a period of time associated with poor user performance.

19. The device of claim 11, wherein updating a game data stream includes at least one of embedding and adding a sound component of a sound cue to a game data stream for output.

20. The device of claim 11, wherein the controller is configured to detect a user reaction to the sound cue and controlling a game data stream based on the user reaction.
